(19) United States
(12) Patent Application Publication
(10) Pub. No.: US 2009/0228957 A1
(43) Pub. Date: Sep. 10, 2009

(54) System and a Method for Authorizing Processes Operations on Internet and Intranet Servers

(76) Inventors: Moshe Basol, Raanana (IL); David Allouch, Raanana (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 10/596,938

(22) PCT Filed: Dec. 30, 2004
(86) PCT No.: PCT/IL04/01191

§ 371 Date: Jun. 29, 2006

Related U.S. Application Data
(60) Provisional application No. 60/534,190, filed on Jan. 2, 2004.

(51) Int. Cl. G06F 21/00

(52) U.S. Cl. 726/4; 726/1

(57) ABSTRACT

Disclosed is a system and a method for providing network security for online servers by tracking the users' activity on them and preventing the occurrences of unauthorized events. This invention implements a highly efficient security approach which focuses on the Internet and Intranet servers' environment and operates inside it. The preferred embodiment of the present invention functions at the operating system level of the servers, it validates that each process on the servers is in keeping with a set of rules and with the privileges of the users. The system compares between the level and scope of permissions given to the users and the operation done by processes that relate to them on the different servers of the environment. Whenever incompatibilities or inconsistencies are found, the security system filters out the inappropriate processes and updates a security log.

### BACKGROUND OF THE INVENTION

1. Field of the Invention

The present invention relates generally to network security and in particular to a system and a method for authorizing Internet and Intranet session activities on network servers.

2. Background Art

Prior art of providing security to servers, which are connected to the Internet and allow access to their resources, includes several techniques of preventing and restricting the access of unauthorized users. Such techniques include using firewalls, secure servers and demanding users to identify themselves before granting them access. The main drawback of such security methods is that once the users gain access, even if it is a highly restricted one, complex multi server systems find it hard to track the users' activities on the servers and prevent the misuse of the servers' resources.

Executing the users' requests in multi server systems usually requires the initiation of many processes on the different servers. In such cases the applications may not obtain any information about the processes' owners since their processes are initiated by other servers and they communicate only with them. In such cases the processes may all be owned by a single user ID with low permissions. Such cases make tracking a single user's activity impossible and this becomes a major security loophole.

U.S. Pat. No. 6,199,113 addresses this problem by establishing a session key for the users on their entry into a secured server. The session key is established only for users whose identity is authenticated by an authenticating process, which includes comparing the received details of their identity as given by the browser and the system's database. This solution guarantees that only the sessions of authorized users may operate on the secured server and that users that manage to enter without permission cannot gain access to the servers' resources. This may be an effective solution for systems which want to ensure that their access restriction are enforced, but does not provide the needs of systems which do not operate under the secure system criteria, and which are required to be open to all users.

There is therefore a need for a security system that suits the modes of operation of open complex systems, such as systems operating in multi tier architecture, and wants to grant limited access to all users without allowing exploitation of their resources. US Patent Application No. 20020174220 provides a partial solution to this problem. It restricts the number of processes that each user may initiate on the servers and thus ensures that the system's computing resources are not all captured by a single user. This may reduce opportunities for denial of service attacks on the security of a server node, but it does not examine the nature of the operations which are executed by the users. In order to allow a system to supervise the activities of its users there is a need for a means for limiting the operations of the system's users by monitoring and filtering out unauthorized activities. Since at any given moment numerous processes may operate on these systems, an additional requirement of such a system is that the monitoring operation would not burden the resources of the servers and the network.

### SUMMARY

Disclosed is a security system for preventing unauthorized processes activities within a network server environment. Each process is associated to at least one identified communication session and the process authorization is determined in accordance with predefined rules. The rules refer to the properties of the identified communication session. The system also includes a filtering module installed on each server for blocking unauthorized processes activities in accordance with determined authorization. At least one agent may be installed on at least one of the protected servers within the server network environment. The agent enables correlating between processes and sessions on different servers.

For each process an identification code of the identified communication session is added to the process information vector. The identification code may replace redundant information in the process information vector. The processes are associated to the identified communication session by a unique process identifier. The communication session may be identified according to a unique Transmission Control Protocol (TCP) port ID. The identified session properties may be one of the following: sign in parameters, initial session type parameters or hyperlink session address type parameters. Also disclosed is a security method for preventing unauthorized processes activities within a network server environment. The method comprises the steps of associating each process to at least one identified communication session and determining process authorization in accordance with predefined rules. The rules refer to the properties of the identified communication session.

The method also includes the following steps of filtering processes activities in accordance with the determined authorization and correlating process and sessions on different servers within the server network environment.

The association includes the step of adding an identification code of the identified communication session to the process information vector. The code may replace redundant information in the process information vector. The processes are associated to the identified communication session by a unique process identifier. The identified session properties are sign in parameters initial session type parameters or hyperlink session address type parameters.

### BRIEF DESCRIPTION OF THE DRAWINGS

The above, as well as other advantages of the present invention will become readily apparent to those skilled in the art from the following detailed description of a preferred embodiment when considered in the light of the accompanying drawings in which:

FIG. 1 is a block diagram illustrating examples for two possible environments in which the said security system may operate;

FIG. 2 is a block diagram illustrating the user identification process according to the preferred embodiment of the present invention;

FIG. 3 is a flow chart illustrating the principle of operation of the preferred embodiment of the present invention;

FIG. 4 is a block of the three main modules of the security system 400 according to the preferred embodiment of the present invention.

### DETAILED DESCRIPTION OF THE PREFERRED EMBODIMENT

The present invention is a new and innovative system and method for providing network security for online servers by tracking the users' activity on them and preventing the occurrences of unauthorized events. This invention implements a highly efficient security approach which focuses on the Internet and Intranet servers' environment and operates inside it. The preferred embodiment of the present invention functions at the operating system level of the servers, it validates that each process on the servers is in keeping with a set of rules and with the privileges of the users, whereas a user is the originator of the request and is therefore the session holder; the user is the virtual entity which is using the service on the server. The system compares between the level and scope of permissions given to the users and the operation done by processes that relate to them on the different servers of the environment. Whenever incompatibilities or inconsistencies are found, the security system filters out the inappropriate processes and updates a security log.

This method blocks both unauthorized access to resources and prevents the misuse of accessible resources. Unauthorized access may include, for instance, attempts of unlicensed users to operate within the system whilst misuse of resources may include actions of users which breach their given privileges such as attempts to alter database records by users with read-only permissions. Preventing misuse by users is the most significant capacity of the present security system since prior art includes several well known solutions for preventing unauthorized users from gaining access into servers and networks, but once users enter it, it is much more difficult to monitor their activities; this issue remains the blind spot of most of the prevailing security strategies.

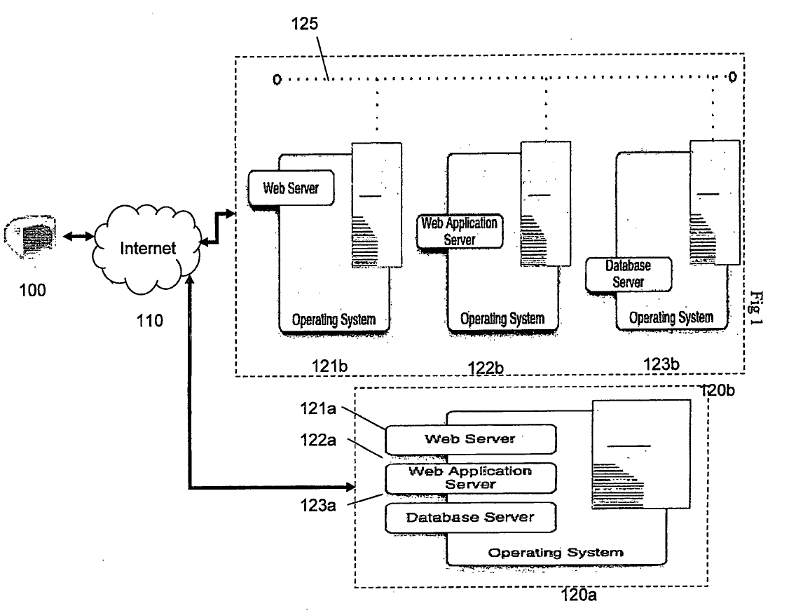

FIG. 1 illustrates an example for environments in which the said security system may operate. The client 100 connects the system 120 via the internet or Intranet 110. The system may be comprised of a single tier architecture 120a or of a multi tier architecture 120b. While in the single tier architecture all facilities 121a, 122a, 123a are run on a single server 120a, in multi tier systems 120b the system facilities are divided into several servers 121b, 122b, 123b which are interconnected via a local network 125 and cooperate in accomplishing tasks.

A client user 100, which connects system 120, initiates a session by creating action requests in system 120, such as gaining access to files or retrieving information from databases. To execute such actions the system 120 must create processes in its servers. Complex tasks may demand creating more then one process, especially if they are executed on a multi-tier architecture.

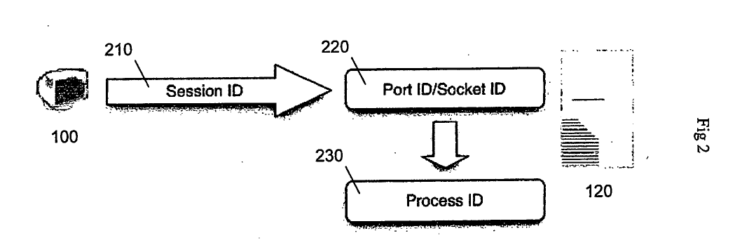

FIG. 2 illustrates the user identification process. Tracking the progress of each user is achieved by using tools which are similar in nature to those used by load balancer techniques. Users may sign in to server 120 either by using a unique personalized user identifier such as a username or by using browsing means that do not demand identification. Whenever a username is used, the system can easily associate the identity of the users to the session IDs produced by their requests. But even when users enter the server without yielding personal details, their requests may be traced back to the originator browser identity, which initiated the request, through the request's header. Since the users' requests are usually sent sequentially, each request contains an individual header. As illustrated in FIG. 2, the header of a request initiated by the client 100 contains a session ID 210 (the cookie which is attached to the header of each request). The security system identifies the session ID 210, and if for any reason a session ID 210 is not available, the security system creates a unique identifier for the session on the request's first appearance. Alternatively, other available information may be used as criteria for session validation such as the name of the website from which the session was initiated or an indicator from a specific security module used in the system. This option may be used in information environments where the security is such that knowing that the session owner has arrived via a certain website, has entered through a specific security module or any other session information is sufficient for determining the privileges of that session, or in environments where highly specific combinations of conditions are used to define the session's privileges.

The system then links all the processes 230 to the ID 210 of the initiating session by tracking the unique Transmission Control Protocol (TCP) port ID 220 given to the request. The port ID 220 may be associated with the session ID 210 since they are both unique identifiers. This pairing allows the security system to track which session activates each of the processes 230 in system 120. The security system performs this tracking by attaching the session ID information to the process itself.

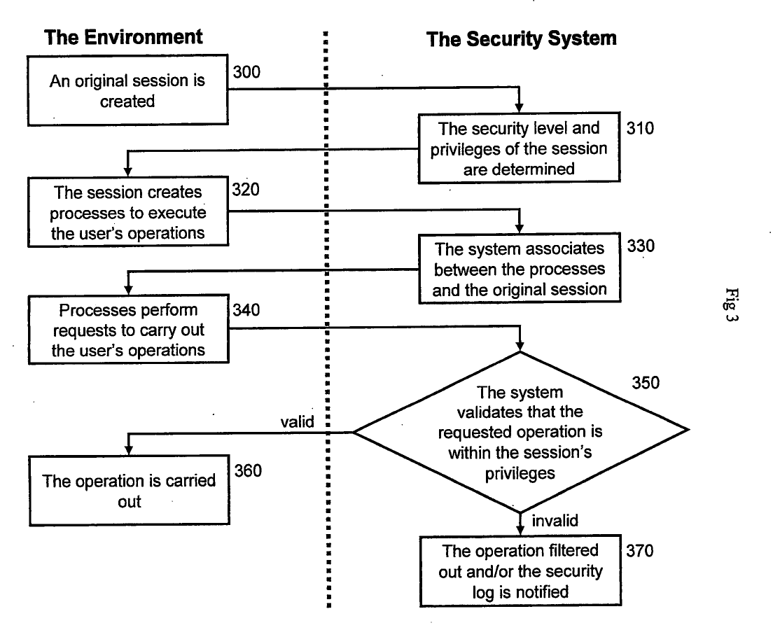

FIG. 3 is a flow chart illustrating the security system's operation. First, a user connects the environment and a session is created 300. The security system then determines the privileges and the security level of the session 310. In order to execute the user's requests the session creates designated processes 320. The security system can then associate the processes and the original session which initiated them by attaching a session identification criteria to the processes 330. While operating within the system processes can create additional processes, producing a hierarchical structure of processes at the kernel level. By referring each process to the hierarchical tree it belongs to the system can associate the session identification criteria to each process.

Next, the processes form requests which comply with the user's operations 340, such as requesting access to specific records in a database or requests for gaining access to specific files. At this stage the security system performs a validation procedure which correlates the privileges given to the original session and the operation which the processes attempt to execute 350. Provided that the operation falls within the privileges of the session the operation is granted and carried out 360, but if the security system finds that the original session which created the process does not have privileges to perform the operation, said operation is terminated and/or reported in a designated security log file.

Referring back to FIG. 1, in the case of multi tier systems, server 121b may also transfer tasks to the other servers of the system 122b, 123b through network 125. The initial process creates a connection via network 125 with servers 122b, 123b in order to transfer commands and arguments. It then waits for a result through the same connection. In this case, when tasks are transferred from one server to the next, the same procedure of correlating the session ID with the processes it creates through the socket connection is repeated. This allows the security system to trace back the session ID, and through it the identity of its user, for every process in the network.

The processes may be tracked using the unique process identifier to identify each process. For this purpose memory is allocated for the process identifier in the kernel of the operating system. Alternatively, due to the large number of sessions and processes which may run simultaneously in complex environments, adding information which tracks every single process might severely burden the system's resources and degrade its performance. For this reason the preferred embodiment of the present security system is especially designed to overcome this problem. In order to economize the resources usage, the system uses redundant fields in the process information vector, such as the TTY process information field in the Unix operating system. The TTY process information holds the identification information of the terminal which initiated the process. Since the processes at hand are initiated by external sources and not via local terminals, this information is redundant and its memory allocation may be used for the purposes of the present security system, without jeopardizing the integrity of the environment. Other systems have other redundant fields in their session information vector which may be used for the same purpose.

Since the tracking process requires only the information attached to the process itself, the process does not require additional memory allocation or additional network communication to be transferred between the different levels of the environment. A security system which requires additional information transference would have had to overcome information transfer restrictions which are inherent to such environments.

A block diagram of the preferred embodiment of the present invention is illustrated in FIG. 4. The security system 400 comprises three main modules. The first is a session request identification module 420, operating on the web server 121. The session request identification module 420 collects the information about the different processes, socket connections, port numbers, and session IDs. It also manages the information about the processes which operate on other servers in the environment; the information is shared through agents installed on the different servers. As mentioned above, the session request identification module 420 uniquely identifies the origin session of each process in the environment and stores the session identification criteria in the process information vector of every process. Each process in the system may then be easily tracked back to the session it derived from without having to employ extensive calculation resources for this purpose.

The second is a central module 440 which operates according to a set of rules that take into account the collected information about the session ID and its history. The central module 440 can determine for each operation whether it is within the scope of the session privileges. It can also manage other factors which relate to operations inside the environment, such as the division of its resources. This ability enables the security system to protect the environment from malicious exploitation of its resources such as “denial of service” attacks. The rules of the central module 440 may be fully configured and managed by the administrator by using the security system's administrative tools. The security system's software also provides the administrator the ability to configure and reload these rules from a remote management console.

The third module is the process filter 430 which executes the commands given by the central module 440 and restricts the operation of processes that are found to be invalid. The process filter 430 may also keep track of all attempts to breach the environment's security by updating a security log with information about those attempts. The security system may be configured to respond differently to each type of security breach. Some types may be defined as basically harmless and would then be only reported but not terminated automatically, while some may be classified as harmful and should be filtered out.

When the system operates on a single tier architecture the central module 440 may be implemented as a logical module and it does not necessarily need to be a separate entity. In such cases the central module 440 may partially reside in the session request identification module 420, and partially in the process filter module 430.

While the above description contains many specificities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A security system for preventing unauthorized processes activities within a network server environment, wherein each process is associated to at least one identified communication session and the process authorization is determined in accordance with predefined rules, wherein said rules refer to the properties of the identified communication session.

2. The system of claim 1 further comprising of a filtering module installed on each server for blocking unauthorized processes activities in accordance with determined authorization.

3. The system of claim 1 wherein the system includes at least one agent installed on one of the protected servers within the server network environment, said agent enables correlating between processes and sessions on different servers.

4. The system of claim 1 wherein for each process an identification code of the identified communication session is added to the process information vector.

5. The system of claim 4 wherein the identification code replaces redundant information in the process information vector.

6. The system of claim 1 wherein the processes are associated to the identified communication session by a unique process identifier.

7. The system of claim 1 wherein the identified session properties are sign in parameters.

8. The system of claim 1 wherein the identified session properties are initial session type parameters.

9. The system of claim 1 wherein the identified session properties are hyperlink session address type parameters.

10. The system of claim 6 wherein the communication session is identified according to a unique Transmission Control Protocol (TCP) port ID.

11. A security method for preventing unauthorized processes activities within a network server environment, said method comprising the steps of:
associating each process to at least one identified communication session;
determining process authorization in accordance with predefined rules, wherein said rules refer to the properties of the identified communication session.

12. The method of claim 11 further comprising the step of filtering processes activities in accordance with the determined authorization.

13. The method of claim 11 further comprising the step of correlating between process and sessions on different servers within the server network environment.

14. The method of claim 11 wherein the association includes the step of adding an identification code of the identified communication session to the process information vector.

15. The method of claim 14 wherein the identification code replaces redundant information in the process information vector.

16. The method of claim 11 wherein the processes are associated to the identified communication session by a unique process identifier.

17. The method of claim 11 wherein the identified session properties are sign in parameters.

18. The method of claim 11 wherein the identified session properties are initial session type parameters.

19. The method of claim 11 wherein the identified session properties are hyperlink session address type parameters.

20. The method of claim 11 wherein the communication session is identified according to a unique Transmission Control Protocol (TCP) port ID.
